(19) United States
(12) Patent Application Publication
(10) Pub. No.: US 2026/0091431 A1
(43) Pub. Date: Apr. 2, 2026

(54) THREE DIMENSIONAL PRINTER

(71) Applicant: Alaris Defense Inc., Hutto, TX (US)

(72) Inventors: Luke Johnson, Cedar Park, TX (US); Brian Cox, Florence, TX (US); John Stockton, Austin, TX (US); Quinlan Yee Shuck, Troy, MI (US)

(73) Assignee: Alaris Defense Inc., Hutto, TX (US)

(21) Appl. No.: 19/343,293

(22) Filed: Sep. 29, 2025

Related U.S. Application Data
(60) Provisional application No. 63/701,469, filed on Sep. 30, 2024.

(51) Int. Cl. B22F 12/45; B22F 10/28; B22F 12/13; B22F 12/41; B22F 12/53; B33Y 10/00; B33Y 30/00; B33Y 40/10

(52) U.S. Cl. CPC B22F 12/45; B22F 10/28; B22F 12/13; B22F 12/41; B22F 12/53; B33Y 10/00; B33Y 30/00; B33Y 40/10; B22F 2998/10

(57) ABSTRACT

A light system for a directed energy deposition three dimensional printer, a three-dimensional printer, and a method of printing with a three dimensional printer, the three dimensional printer including the light system including an array of light sources and an optical element for one or more of the light sources and the array of light sources includes at least two light sources. The optical element directs light emitted from the one or more light sources towards a focal region on a microwire and a substrate. The light sources provide sufficient energy to at least partially melt the substrate in the focal region. The microwire exhibits a diameter in the range of 0.1 millimeters to 1 millimeter and the microwire includes at least one of a transition metal, aluminum and magnesium.

### CROSS REFERENCE TO RELATED APPLICATIONS

The present application claims the benefit of U.S. Provisional Application No. 63/701,469, filed Sep. 30, 2025, the teachings of which are incorporated herein by reference.

### INTRODUCTION

Three-dimensional printing, like many forms of additive manufacturing, involves the creation of parts by the layer by layer deposition of material. Each subsequent layer of material is representative of subsequent cross-sections of the part. Directed energy deposition is one form of 3D printing that may use metals and metal alloys for forming a three-dimensional part. During the directed energy deposition process, an energy source, such as an electron beam, laser, or arc, is directed towards and impinges upon the substrate creating a melt pool, and the feed material is added to the melt pool. Directed energy deposition provides the ability to fabricate parts that are relatively complex and produce parts with metals that may be hard to process using other manufacturing processes.

In laser wire directed energy deposition, wire is used as a feed material. The feed material is melted and deposited either directly on the print bed or on a previously printed layer. In addition to fabricating components, laser energy deposition may also be used to repair and coat parts. However, challenges remain in laser directed energy deposition systems and processes including relatively poor resolution of the parts produced, small spot size, and often insufficient energy input, reducing throughput rates compared to other methods of additive manufacturing.

Thus, while the current laser wire directed energy deposition is useful for its intended purpose, there is room in the art for improvements in printer design and methods of producing three-dimensional components.

### SUMMARY

According to various aspects, the present disclosure relates to a three-dimensional printer. The three dimensional printer includes a light system including an array of light sources and an optical element for one or more of the light sources and the array of light sources includes at least two light sources. Each light source emits light at one or more wavelengths in the range of 350 nanometers to 1100 nanometers, and the optical element directs light emitted from the one or more light sources towards a focal region on a microwire and a substrate. The light sources provide sufficient energy to at least partially melt the substrate in the focal region. The three-dimensional printer also includes a print head including a print nozzle for feeding the microwire into the focal region, wherein the microwire exhibits a diameter in the range of 0.1 millimeters to 1 millimeter and the microwire includes at least one of a transition metal, aluminum and magnesium. The three-dimensional printer further includes a print bed for supporting the substrate, wherein at least one of the print head and the print bed are moveable relative to the other.

In embodiments of the above, each light source includes a laser diode.

In any of the above embodiments, the print nozzle is at least partially surrounded by the light system. In further embodiments, the print nozzle includes a heater for preheating the microwire.

In any of the above embodiments, power provided to each of the light sources in the array of light sources is individually adjustable and selected based on at least one of a microwire geometry and a geometry of the print.

In any of the above embodiments, the optical element is at least one of a diffractive element and a reflective element.

In any of the above embodiments, at least one light source emits light at one or more electromagnetic wavelengths in the range of 400 nanometers to 500 nanometers.

In any of the above embodiments, at least one light source emits light at one or more electromagnetic wavelengths in the range of 890 nanometers to 1100 nanometers.

In any of the above embodiments, the optical element is included in an optical train and the optical train further includes diffractive features for each light source.

In any of the above embodiments, individual optical elements are used for each light source.

In any of the above embodiments, a single optical element or a single optical train is associated with at least a portion of the light sources.

According to various additional aspects, the present disclosure relates to a light system for a directed energy deposition three-dimensional printer. The three-dimensional printer includes an array of light sources including at least two light sources, wherein each light source emits light at one or more wavelengths in the range of 350 nanometers to 1100 nanometers. The three-dimensional printer further includes an optical element, wherein the optical element directs light emitted from each light source towards a focal region on a microwire and a substrate. The light sources provide sufficient energy to at least partially melt the substrate in the focal region. In addition, the microwire exhibits a diameter in the range of 0.1 millimeters to 1 millimeter, and the microwire includes at least one of a transition metal, aluminum and magnesium.

In embodiments of the above, each light source includes a laser diode.

In any of the above embodiments, power provided to each of the light sources in the array of light sources is individually adjustable.

In any of the above embodiments, the optical element is at least one of a diffractive element and a reflective element.

In any of the above embodiments, at least one light source emits light at one or more electromagnetic wavelengths in the range of 400 nanometers to 500 nanometers.

In any of the above embodiments, at least one light source emits light at one or more electromagnetic wavelengths in the range of 890 nanometers to 1100 nanometers.

According to various additional aspects, the present disclosure relates to a method of printing a three-dimensional part. The method includes feeding a microwire through a print nozzle, wherein the microwire exhibits a diameter in the range of 0.1 millimeters to 1 millimeter and the microwire includes at least one of a transition metal, aluminum, and magnesium. The method further includes emitting light onto the microwire and a substrate using an array of light sources including at least two light sources. Each light source emits light at one or more wavelengths in the range of 350 nanometers to 1100, and an optical element for directing one or more of the light sources onto a focal region. The method yet further includes melting the substrate to form a melt pool and feeding the microwire into the melt pool. The method further includes solidifying the melted print material.

In embodiments of the above, the method further includes preheating the microwire as it is fed through the print nozzle.

In any of the above embodiments, the method includes directing a portion of the light sources onto the substrate in a print direction.

### BRIEF DESCRIPTION OF THE DRAWINGS

The drawings described herein are for illustration purposes only and are not intended to limit the scope of the present disclosure in any way.

FIG. 1 illustrates a three-dimensional printed using directed energy deposition according to embodiments of the present disclosure.

FIG. 2 illustrates a close up of a light system of a three-dimensional printed using directed energy deposition, according to embodiments of the present disclosure.

FIG. 3 illustrates a close up of a print nozzle and energy focal region, according to embodiments of the present disclosure.

FIG. 4 illustrates a method of forming a three-dimensional printed part, according to embodiments of the present disclosure.

### DETAILED DESCRIPTION

The following description is merely exemplary in nature and is not intended to limit the present disclosure, application, or uses. The use of terms such as “above,” “below,” “upper,” “lower,” “x-direction”, “y-direction”, “z-direction” or other like terms to describe a spatial relationship between various components or to describe the spatial orientation of aspects of such components should be understood to describe a relative relationship between the components or a spatial orientation of aspects of such components, respectively, as the device described herein may be oriented in other directions.

The present disclosure is directed to a light source array for a microwire, laser directed energy deposition, three-dimensional printer and a method of depositing a print material including at least one of a metal, metal alloy, and metals alloyed with non-metallics. A metal alloy may be understood as an alloy of two or more metals. The light from the light source in the array is focused on a focal region near the tip of the nozzle using one optical element or more than one optical elements in an optical train, such as diffractive elements including individual lenses, a single lens, or multiple lenses, wherein each lens is for one or more light sources. Additionally or alternatively, the optical elements include reflective elements including individual reflective elements, a single reflective element, or multiple reflective elements, wherein each reflective element is for one or more light sources. The print material includes at least one of a metal, metal alloy, and one or more metals alloyed with one or more non-metallic elements. A metal alloy may be understood as an alloy of two or more metals. The print material is provided in the form of a microwire having a diameter 174 of 1 millimeter or less, such as all values and increments in the range of 0.1 millimeters to 1 millimeters and, in embodiments, 0.1 millimeters to 0.5 millimeters. In embodiments, the print material includes, but is not limited to, at least one of a transition metal, including but not limited to refractory metals such as niobium and tungsten, aluminum, magnesium, and alloys thereof including transition metal alloys such as stainless steel, nickel-chromium alloys such as HAYNES 230, titanium based alloys, refractory metal alloy, aluminum alloys, and magnesium alloys.

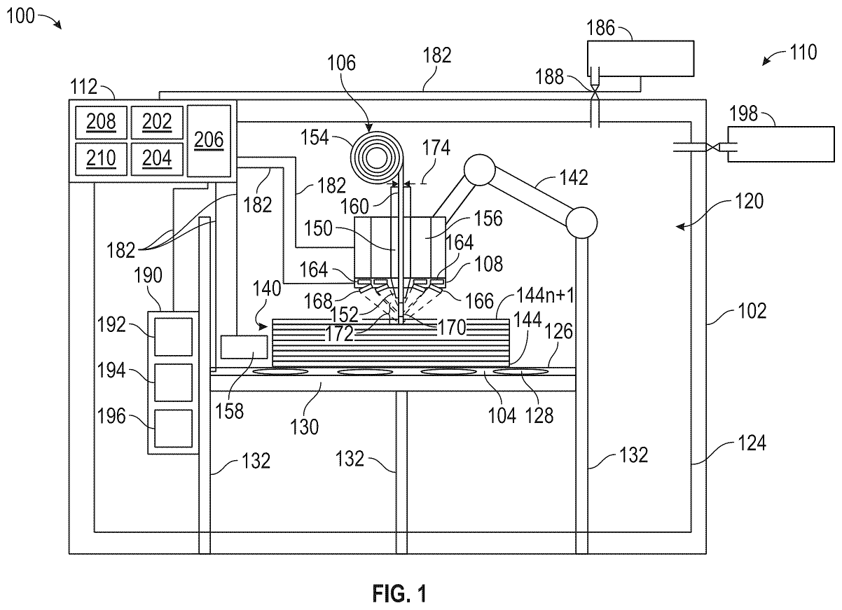

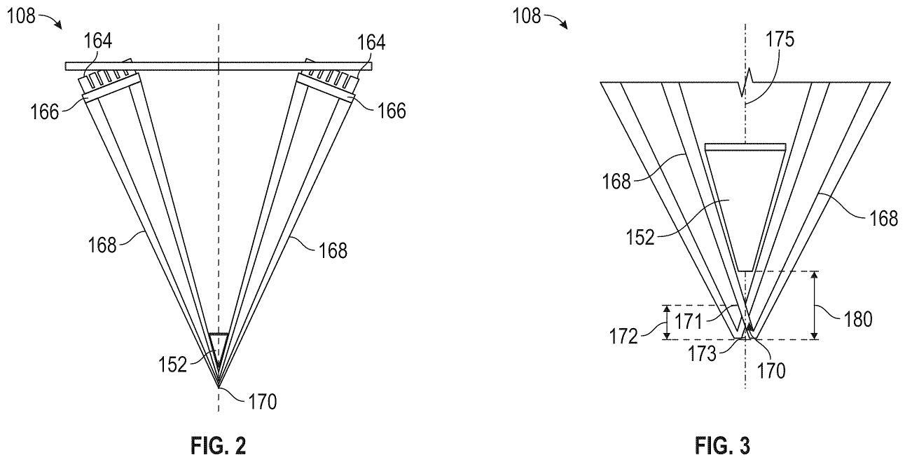

Turning now to FIGS. 1 through 3, these figures illustrate a general embodiment of a three-dimensional printer 100 using laser directed energy deposition for depositing the microwire to form a three-dimensional part 140. The three-dimensional printer 100 generally includes a process chamber 102, a print bed 104, a feed system 106, a light system 108, an environmental control system 110, and a controller 112.

The process chamber 102 encloses a volume 120 in which the print bed 104, at least a portion of the feed system 106, the light system 108, and at least a portion of the environmental control system 110 are located. In embodiments, such as the illustrated embodiments, the control system 112 is isolated from the volume 120 of the process chamber 102 to protect the electronic components therein from elevated temperatures or gasses that may be used in production. In alternative embodiments, the control system 112 may be included in the volume 120 of the process chamber 102. An access panel or door 124 provides access into the volume 120 of the process chamber 102.

The print bed 104 is located in the enclosed volume 120 of the process chamber 102. The print bed 104 includes a print surface 126 that may be removable from the print bed 104. In embodiments, the shape of the print bed 104 and print surface 126 onto which the print material is deposited on may include any number of shapes, such as rectangular, circular, oblong, etc. In embodiments, the at least one of the print surface 126 and the print bed 104 is heated using one or more heating elements 128. Depending on the material that the print bed 104 is formed from the heating elements 128 may be resistive heating elements, radiant heating elements, and induction heating elements.

In embodiments, the print bed 104 is mounted on a support bed 130 that is connected to one or more linear adjustment drives 132. Three linear drives 132 are illustrated, however up to eight linear drives 132 may be present, or more, depending on the expected weight of the printed three-dimensional part 140. The linear adjustment drives 132 raise and lower the print bed 104 relative to the print nozzle 150 of the feed system 106 and the light system 108. In embodiments, the linear adjustment drives 134 include at least one of a ball screw drive, a roller screw drive, and a linear motor. In alternative embodiments, the print bed 104 is stationary and the feed system 106 and the light system 108 are mounted to a feed system gantry 142, which is articulated relative to the print bed 104. In additional or alternative embodiments, the support bed 130 is a multi-axis turn table and the print bed 104 is mounted on the multi-axis turn table. Further, in embodiments, a partial part or a component to be repaired, i.e., a repair component, is mounted onto the print bed 104. In embodiments, the print surface 126, partial part, or repair component may form a non-planar surface onto which the print material is deposited.

The feed system 106 includes a print nozzle 150, a nozzle tip 152, and a microwire supply 154 such as the illustrated spool. The print nozzle 150, in embodiments, includes one or more heaters 156 for preheating the microwire 160. Again, depending on the composition of the print nozzle 150 and the print material of the microwire 160, the heaters 156 may include one or more resistance heaters, induction heaters, and radiant heaters that heat either or both the print nozzle 150 and the print material 160. The nozzle tip 152 extends down from the base of the print nozzle 150 towards the print bed 104. The nozzle tip 152 may also be heated using heaters 156 similar to those described above.

In embodiments, the feed system gantry 142 includes a robot arm configured to articulate the feed system 116 relative to the print bed 104 and the printed three-dimensional part 140 providing at least two axis and up to seven axis of movement. In alternative embodiments, the feed system gantry 142 is a gantry that provides movement in a plane defined by two axis, the plane being at least one of 1) generally parallel to the print bed 104, and 2) orthogonal to the movement of the print bed 104 up and down relative to the print nozzle 150 and feed system 106.

The light system 108 includes an array of light sources 164 and one or more optical elements 166 to point the light 168 emitted from the light sources 164 to a focal region 170 on the microwire 160 and onto a substrate 144n+1. The substrate 144n+1 is understood as at least one of the print surface 126, a previously printed layer (typically the last printed layer), a partial part, and a repair component. In embodiments, the light system 108 is mounted as a single unit surrounding at least a portion of the periphery of the print nozzle 150, and in embodiments surrounding the periphery of the print nozzle 150, using a mechanical mount. Further, in embodiments, the light system 108 extends along the entire length of the print nozzle 150 or at least a portion of the length of the print nozzle 150. Alternatively, the light system 108 may be mounted to the gantry 142. In preferred embodiments, the light sources 164 include laser diodes, which are understood as semiconductor devices that emit light when provided with electrical current. In alternative embodiments, the light sources 164 may include light emitting diodes.

The light system 108 includes in the range of two to twenty light sources 164, including all values and ranges therein. In embodiments, the light sources 164 emit light in at least one wavelength in the range of 350 nanometers to 1100 nanometers, including all values and ranges therein, such as in the range of 400 nanometers to 500 nanometers, 450 nanometers to 750 nanometers, 700 nanometers to 950 nanometers, 890 nanometers to 1100 nanometers, etc. In embodiments, the light sources 164 may individually emit light in one or more wavelengths in the ranges of 400 nanometers to 500 nanometers, 450 nanometers to 750 nanometers, 700 nanometers to 950 nanometers, 890 nanometers to 1100 nanometers. In yet further embodiments, at least 65 percent or more of the light sources 164, and up to 100 percent of the light sources 164 present emit light exhibiting one or more electromagnetic wavelengths in the range of 400 nanometers to 500 nanometers, including all values and ranges therein. The remaining light sources 164, to total 100 percent, exhibit one or more electromagnetic wavelengths in the range of 500 nanometers to 1100 nanometers including all values and ranges therein. In further embodiments, up to 35 percent of the light sources present emit light exhibiting one or more electromagnetic wavelengths in the range of 890 nanometers to 1100 nanometers including all values and ranges therein. The power of each light source 164 may be individually adjusted allowing shifting of the light 168 incident on the microwire 160 in axis generally parallel to at least one of the substrate 144n+1 and the print bed 104 as well as generally orthogonal to at least one of the substrate 144n+1 and the print bed 104. In embodiments, such shifting may be used to compensate for at least one of microwire 160 geometry and print geometry.

Each light source 164 is aligned with one or more optical element 166 to point the light sources 164 to the focal region 170. More than one optical element present to manipulate the light source 164 is referred to herein as an optical train. In embodiments, a single optical element 166 or a single optical train is used for each light source 164. Alternatively, one or more optical elements 166 may be used for more than one of the light sources 164 wherein features are formed in the optical elements for each of the light sources 164. Alternatively, each light source may have more than one optical element including but not limited to wavelength filters to limit light entering back into the light source in an optical train.

In embodiments, the optical elements 166 are diffractive optical elements, which may be included in an optical train. Diffractive optical features may be provided for each light source 164. The diffractive optical features may be formed as a single optical element 166 associated with all the light sources 164, optical elements 166 associated with a plurality of the light sources 164, or optical elements 166 each associated with a single light source 164. The individual optical elements 166 may be at least one of cylindrical, spherical, and planar. Various materials may be used to form the diffractive optical elements 166 such as, but not limited to, BK-7. In additional or alternative embodiments, the optical elements 166 are reflective, the reflective optical elements include, but are not limited to, a curved mirror, a multi-faceted mirror, a smooth mirror, and combinations thereof. Similarly, the reflective optical features may be formed as a single optical element 166 associated with all the light sources 164, optical elements 166 associated with a plurality of the light sources 164, or optical elements 166 each associated with a single light source 164.

As illustrated in FIG. 1, among the light sources 164, the focal region 170 may be generally cylindrical shape. Alternatively, non-cylindrical shapes may be used, such as frustoconical or conical. In embodiments, the focal region 170 may exhibit a height 172 in the range of the diameter 174 of the microwire 160 to ten times the diameter 174 of the microwire 160, including all values and ranges therein, and a diameter 174 in the range of the diameter of the microwire up to 200 percent greater than the diameter 174 of the microwire 160, including all values and ranges therein. In further embodiments, at least a portion of the light sources 164 may shift in the direction of printing to begin preheating and melting the substrate 144n+1 and microwire 160 in the region where the microwire 160 will be deposited next. Shifting of the light sources 164 may be facilitated by turning one or more light sources 164 in the light source array on and off or altering the direction the optics point the light sources 164 in.

In embodiments, the focal region 170 encompasses both 1) a portion near the end the microwire 160 proximal to the print bed 104 and 2) the substrate 144n+1, which, as noted above, may be understood as at least one of the last deposited layer, the print surface 126, a partial component, or a repair component. In further embodiments, the distribution of the light in the focal region 170 may exhibit a bell curve, wherein the greatest intensity of the light is in the center of the height 172 of the focal region 170 or the bottom third of the height 172 of the focal region 170, decreasing towards the ends 171, 173 of the focal region 170 along an axis 175 defined by the print nozzle 152. Alternatively, the distribution of the light in the focal region 170 may increase towards the substrate 144n+1.

In embodiments, melting is seen in the substrate 144n+1 and a melt pool is created. For example, in embodiments where the substrate 144n+1 is the last deposited layer, the last deposited layer 144n+1 melts in and, in embodiments proximal to, the focal region 170. The microwire 160 is fed into the melt pool and the melt pool melts the microwire 160. In additional or alternative embodiments, melting may be seen near the end of the microwire 160 proximal to the substrate 144n+1. As illustrated in FIG. 3, in embodiments, the focal region 170 is a distance 180 in the range of 3 millimeters to 5 millimeters from the end of the nozzle tip 152.

The environmental control system 110 includes a gas supply 186 for supplying inert gas into the volume 120 of the process chamber 102. In embodiments, the inert gas includes argon. Alternatively, the inert gas includes nitrogen or helium. The inert gas may be recirculated through the environmental control system 110, filtering the gas and regulating gas temperature as it recirculates. In additional or alternative embodiments, rather than supplying an inert gas, a reactive gas may be supplied after deposition of the printed three-dimensional part 140 is complete. Such reactive gas may be used to create a passivation layer on the surfaces of the printed three-dimensional part 140. In further embodiments, the gas supply 186 includes at least one of a regulator and a mass flow controller 188 for delivering gas at either a desired pressure or flow rate, respectively, to the process chamber 102.

Further, in embodiments, the environmental control system 110 also includes a temperature controller 190 for controlling the temperature of the volume 120 in the process chamber 102. The temperature controller 190 includes a temperature sensor 192 for measuring the temperature in the volume 120 of the process chamber 102. The temperature controller 190 includes a temperature sensor 192 for measuring the temperature in the volume 120 of the process chamber 102. The temperature controller 194 also includes a heater as well as a fan 196 moving air or gasses around the process chamber 102.

In yet further embodiments, the environmental control system 110 also includes a vacuum 198 for removing gas from the process chamber 102. The vacuum 198 may be a one stage vacuum or two stage vacuum including both a high-pressure and a low-pressure vacuum stage. A valve 199 may be provided between the process chamber 102 and the vacuum 198. In embodiments, the process chamber 102 may be brought to a vacuum in the range of 70 kPa to 1×10⁻¹² Pa, including all values and ranges therein such as 70 kPa to 1×10⁻⁶ Pa, 30 kPa to 1×10⁻² Pa, etc.

The controller 112 is connected to the heating elements 128 in the print bed 104, the linear adjustment drives 132, the heaters 156 in the print nozzle 150, the feed system gantry 142, the light system 108, environmental control system 110, and heater 158 for heating the portion of the three-dimensional part 140 that has been printed, the partial part, or the repair component. The connections between the controller 112 and the other components in the printer are facilitated by conductive wires 182 or by wireless connections facilitated by radio frequency or optical communication protocols. The controller 112 includes one or more processors 202 that executes executable code to control the various functions of the three-dimensional printer 100, including the methods described herein. The executable code is stored in one or more tangible, non-transitory memory device 204 accessible to the controller 112.

In embodiments, the controller 112 also includes one or more displays 206 and user inputs 208. The display 206 includes, in embodiments, a liquid crystal display (LCD) or one or more light emitting diodes (LED) of different colors representing a different machine status. User inputs includes, in embodiments, keyboards, trackpads, touch screen displays, etc., that allow for the user to put information into the controller 112. Further, the controller 112 also includes one or more communication devices 210 for connecting the controller 112 to external devices, such as external computers, smart phones, etc.

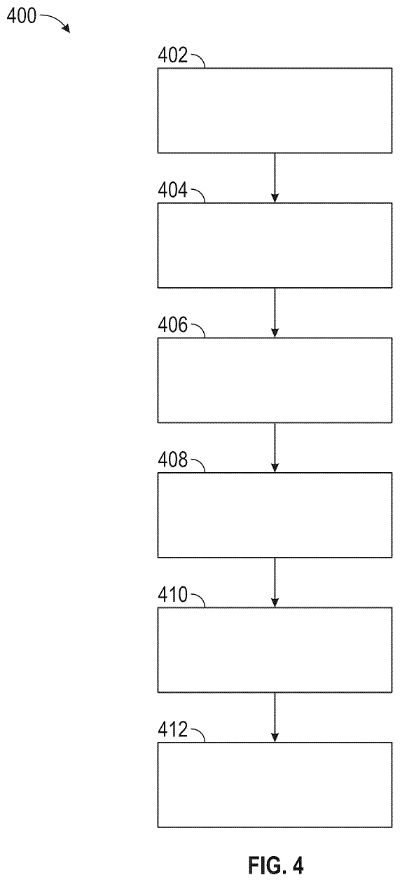

A method 400 of printing a three-dimensional part 140 is illustrated in FIG. 4 with further reference to FIGS. 1 through 3. At block 402 microwire 160 is fed through the print nozzle 150. Optionally, the microwire 160 is pre-heated in the print nozzle 150 at block 404. At block 406 the microwire 160 exits the nozzle tip 152, light 168 is projected onto the substrate 144n+1 as well as onto the microwire 160 from the light sources 164 through the optical elements 166. At block 408, the substrate 144n+1, such as the previously deposited layer, is heated with the light sources forming a melt pool. The microwire 160 is melted by at least one of 1) the melt pool created when heating the substrate 144n+1 and 2) light incident on the microwire 160 from the light sources 164 to form a melted print material. In embodiments, the deposited portion of the three-dimensional part 140 (if present) is also heated through a heater 158 using resistive heating, induction heating, or radiant heating. A clamp may be used to secure the three-dimensional part 140 to the print surface 126, which may be used to conduct heat to the three-dimensional part 140. In yet further embodiments, where a partial part or a repair component is mounted onto the print bed 104, the partial part or repair component may be preheated, melted by the light sources 164, or both preheated and melted by the light sources 164 in a manner similar to a printed three-dimensional part 140. At block 410 the melted print material is deposited onto the substrate 144 n+1. At block 412, the melted print material solidifies.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 112 may also consist of multiple controllers which are in electrical communication with each other. The controller 112 may be inter-connected with additional systems and/or controllers of the three-dimensional printer 100, allowing the controller 112 to access data such as, for example, speed, acceleration, temperatures, pressures, and various other process characteristics of the three-dimensional printer 100.

A processor 202 may be a custom made or commercially available processor, a central processing unit (CPU), a graphics processing unit (GPU), an auxiliary processor among several processors associated with the controller 112, a semi composite conductor-based microprocessor (in the form of a microchip or chip set), a macroprocessor, a combination thereof, or generally a device for executing instructions.

The tangible, non-transitory memory 204 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 204 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 112 to control various systems of the three-dimensional printer 100.

The communication device 210 includes one or more interface circuits. In some examples, the interface circuits include wired or wireless interfaces that are connected to a local area network (LAN), the Internet, a wide area network (WAN), wireless local area networks (WLAN), cellular networks, or combinations thereof.

The light system, laser, direct energy deposition three-dimensional printer, and method of three-dimensional printing using the light system described herein exhibits a number of advantages. These advantages include the ability to finely tune the focal region of light that is incident on the microwire. These advantages further include the ability to alter the dimensions and locations of intensity of the light incident on the microwire. These advantages also include the ability to individually control each lights source, including the power, intensity and wavelength of each light source.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A three-dimensional printer, comprising:
a light system including an array of light sources and an optical element for one or more of the light sources, wherein the array of light sources includes least two light sources, each light source emits light at one or more wavelengths in the range of 350 nanometers to 1100 nanometers, and the optical element directs light emitted from the one or more light sources towards a focal region on a microwire and a substrate, wherein the light sources provide sufficient energy to at least partially melt the substrate in the focal region;
a print head including a print nozzle for feeding the microwire into the focal region, wherein the microwire exhibits a diameter in the range of 0.1 millimeters to 1 millimeter and the microwire includes at least one of a transition metal, aluminum, and magnesium; and
a print bed for supporting the substrate, wherein at least one of the print head and the print bed are moveable relative to the other.

2. The three-dimensional printer of claim 1, wherein each light source includes a laser diode.

3. The three-dimensional printer of claim 1, wherein the print nozzle is at least partially surrounded by the light system.

4. The three-dimensional printer of claim 3, wherein the print nozzle includes a heater for preheating the microwire.

5. The three-dimensional printer of claim 1, wherein power provided to each of the light sources in the array of light sources is individually adjustable and selected based on at least one of a microwire geometry and a geometry of the print.

6. The three-dimensional printer of claim 1, wherein the optical element is at least one of a diffractive element and a reflective element.

7. The three-dimensional printer of claim 1, wherein at least one light source emits light at one or more electromagnetic wavelengths in the range of 400 nanometers to 500 nanometers.

8. The three-dimensional printer of claim 1, wherein at least one light source emits light at one or more electromagnetic wavelengths in the range of 890 nanometers to 1100 nanometers.

9. The three-dimensional printer of claim 1, wherein the optical element is included in an optical train and the optical train further includes diffractive features for each light source.

10. The three-dimensional printer of claim 1, wherein individual optical elements are used for each light source.

11. The three-dimensional printer of claim 1, wherein a single optical element is associated with at least a portion of the light sources.

12. A light system for a directed energy deposition three-dimensional printer, comprising:
an array of light sources including at least two light sources, wherein each light source emits light at one or more wavelengths in the range of 350 nanometers to 1100 nanometers; and
an optical element, wherein the optical element directs light emitted from each light source towards a focal region on a microwire and a substrate, wherein the light sources provide sufficient energy to at least partially melt the substrate in the focal region, the microwire exhibits a diameter in the range of 0.1 millimeters to 1 millimeter, and the microwire includes at least one of a transition metal, aluminum, and magnesium.

13. The light system of claim 12, wherein each light source includes a laser diode.

14. The light system of claim 12, wherein power provided to each of the light sources in the array of light sources is individually adjustable.

15. The light system of claim 12, wherein the optical element is at least one of diffractive element and a reflective element.

16. The light system of claim 12, wherein at least one light source emits light at one or more electromagnetic wavelengths in the range of 400 nanometers to 500 nanometers.

17. The light system of claim 12, wherein at least one light source emits light at one or more electromagnetic wavelengths in the range of 890 nanometers to 1100 nanometers.

18. A method of printing a three-dimensional part, comprising:
feeding a microwire through a print nozzle, wherein the microwire exhibits a diameter in the range of 0.1 millimeters to 1 millimeter and the microwire includes at least one of a transition metal, aluminum, and magnesium;
emitting light onto the microwire and a substrate using an array of light sources including at least two light sources, wherein each light source emits light at one or more wavelengths in the range of 350 nanometers to 1100, and an optical element for directing one or more of the light sources onto a focal region;
melting the substrate to form a melt pool;
feeding the microwire into the melt pool; and
solidifying the melted print material.

19. The method of claim 18, further comprising preheating the microwire as it is fed through the print nozzle.

20. The method of claim 18, further comprising directing a portion of the light sources onto the substrate in a print direction.
